(19) United States
(12) Patent Application Publication
(10) Pub. No.: US 2011/0214688 A1
(43) Pub. Date: Sep. 8, 2011

(54) CLEANING SOLUTION FOR SIDEWALL POLYMER OF DAMASCENE PROCESSES

(75) Inventors: Anthony D. Ozzello, JR., San Jose, CA (US); Ying-Liang Chuang, Jhubei City (TW)

(73) Assignee: Lam Research Corporation, Fremont, CA (US)

(21) Appl. No.: 13/040,558

(22) Filed: Mar. 4, 2011

Related U.S. Application Data
(60) Provisional application No. 61/311,122, filed on Mar. 5, 2010.

(51) Int. Cl. C23G 1/00; C11D 7/60

(52) U.S. Cl. 134/2; 510/175

(57) ABSTRACT

An aqueous cleaning solution and a method of use of the cleaning solution are described herein for removing sidewall polymer of a damascene process on a wafer without damaging any low-k material and interconnect material on the wafer.

This application claims priority under 35 U.S.C. §119(e) to U.S. Provisional Application No. 61/311,122 entitled CLEANING SOLUTION FOR SIDEWALL POLYMER OF DAMASCENE PROCESSES, filed Mar. 5, 2010, the entire content of which is hereby incorporated by reference.

### BACKGROUND

Until recently, semiconductor devices with an Al/SiO₂ multilevel interconnection structure have mainly been produced, which use aluminum, aluminum alloy or the like as an interconnect material, and a SiO₂ film as an interlayer dielectric film. In order to reduce the wiring delay caused by the microminiaturization of devices, semiconductor devices with a Cu/low-k multilevel interconnection structure are now being developed, which use Cu as a low-resistance interconnect material; and low-k film (low dielectric constant film) as an interlayer dielectric film having low interconnect capacitance, in place of the SiO₂ film.

In the Al/SiO₂ multilevel interconnection structure, wiring layers and via layers are separately formed; the wiring layers supplying electric current horizontally across a processed wafer; and the via layers forming the wiring through vertical holes that connect the wiring layers. Each wiring layer is formed by producing metal wiring (such as Al) by metal dry etching, and depositing an interlayer dielectric such as SiO₂ film to embed the wiring. After the deposition of an interlayer dielectric such as SiO₂ film, the via layer is formed by subjecting the interlayer dielectric to dry etching to form a hole (via hole), and filling the hole with a metal such as Al or W.

The Cu/low-k multilevel interconnection structure is produced by a process called damascene, wherein the wiring structure is obtained by forming a trench or a hole (via hole) in low-k film by dry etching, and then filling the trench or hole with an interconnect material such as copper. In the method called dual damascene, trenches for wiring and via holes are formed in low-k film, and then filled with an interconnect material such as copper. A dual damascene structure can be formed by a via-first process, wherein the via holes are formed prior to the trenches for wiring; or conversely, by a trench-first process, wherein the trenches for wiring are formed prior to the via holes; or by other processes such as a middle-first process or a dual hard mask process. In the dual damascene process or the like, an interconnect material is used in many cases. In the via-first process, for example, via holes are formed by dry etching and then filled with an interconnect material, followed by lithography and etching for the formation of trenches. Thereafter the interconnect material must be selectively removed.

In the Al/SiO₂ multilevel interconnection structure, the metal etching for the formation of wiring uses a gas such as chlorine or hydrogen bromide, and the via etching for the formation of via holes uses a mixed gas of fluorocarbon gas, hydrofluorocarbon gas, an inert gas such as Ar, oxygen, an oxygen-containing gas such as carbon monoxide, etc. After metal etching or the via etching of the interlayer dielectric for via hole formation, ashing is performed using an oxygen-containing plasma to remove unnecessary substances such as resist and etching residues. The residue remaining after ashing is removed using a removing solution. In the case of metal etching, the residue consists of oxides of aluminum, etc., that contain a small amount of organic substances such as resist. Since this residue is formed on the sidewalls of aluminum wiring, it may be referred to as “sidewall polymer,” “rabbit ear,” and so on. In the case of via etching, the residue consists of oxides or fluorides of Ti, TiN, or other metal barrier films that contain a small amount of organic substances such as resist and fluorocarbon polymers. This residue may also be referred to as “sidewall polymer.” In many cases the residue after metal or via hole etching is subjected to an ashing treatment until the resist is removed using oxygen plasma, with the result that the principal component of the etching residue is an oxide that has been made inorganic.

In the Cu/low-k multilevel interconnection structure, by contrast, the damascene structure of a trench or a via hole in low-k film is formed by dry etching using a fluorocarbon gas mixed with nitrogen, etc. The use of nitrogen in the dry etching gas enhances processing accuracy. However, reaction of the gas with low-k film containing silicon forms a residue of nonvolatile nitrided silicon. If ashing is completely performed using an oxygen-containing plasma to remove the resist and residue after etching, the low-k film will be damaged, causing a change in dielectric constant. This kind of plasma ashing, therefore, is not performed in many cases; instead, ashing may be carried out with a plasma of hydrogen, nitrogen, noble gas, a mixture of these gases, or the like, or light ashing may be carried out with an oxygen-containing plasma. Also, in many cases, to minimize the damage to the low-k film, the resist and interconnect material are not completely removed by ashing. If a nitrogen-containing gas is used for plasma ashing, the residue contains further nitrided silicon in a large amount. In such a case, even after ashing, a relatively large amount of resist, antireflection coating, interconnect material, and nitrogen-containing etching residue such as silicon nitride are present. Even if ashing is carried out to a considerable extent, it is difficult to remove all of the resist, antireflection coating, and interconnect material. As a result, the principal component of the residue present after etching in the damascene process is an organic substance that originates in the resist, antireflection coating, interconnect material, and fluorocarbon polymer, and contains an inorganic substance such as silicon nitride.

### SUMMARY

Described herein is an aqueous cleaning solution effective for removing sidewall polymer produced during a damascene process while minimizing low-k film damage on a wafer containing one or more metallic interconnect materials and one or more low-k interlayer dielectric material films, the cleaning solution comprising 0.01 to 0.1 w/w % of hydrofluoric acid, 1 to 5 w/w % of sulfuric acid, 1 to 15 w/w % of a carboxylic acid, up to 2 w/w % of one or more species of chelating agent, up to 15 w/w % of one or more species of amine, and 75 w/w % or more of water; wherein the cleaning solution does not damage the one or more low-k interlayer dielectric material films.

Sidewall polymer produced during a damascene process on a wafer containing one or more metallic interconnect materials such as Al or Cu and one or more low-k interlayer dielectric material films can be removed without damaging the one or more low-k interlayer dielectric material films by immersing the wafer in the cleaning solution maintained at a temperature from 30 to 70° C. for up to 40 seconds.

### DETAILED DESCRIPTION

Described here are aqueous cleaning solutions for removing sidewall polymer of damascene processes. The cleaning solutions are effective to remove the sidewall polymer without damaging the low-k film or exposed interconnect materials. Examples of the aqueous cleaning solutions are set forth in Table 1, wherein the balance of each solution is water and the numerical values given for HF, H₂SO₄, acetic acid, citric acid, malic acid, IDA, NH₄F, NH₄.HF₂ and TEA are given in w/w %.

TABLE 1

| | | | Acetic | Oxalic | Citric | Malic | | | | | | | Clean |
|---|---|---|---|---|---|---|---|---|---|---|---|---|---|
| | HF | H₂SO₄ | Acid | Acid | Acid | Acid | IDA | NH₄F | NH₄•F₂ | EDTA | TEA | T | Time |
| Test | (w/w %) | (w/w %) | (w/w %) | (w/w %) | (w/w %) | (w/w %) | (w/w %) | (w/w %) | (w/w %) | (w/w %) | (w/w %) | (° C.) | (sec) |
| C1 | 0.06 | 3 | | | | | | | | | | 30 | 4, 8, 16, 30 |
| C2 | 0.06 | 3 | | | | | | | | | | 30 | 8 + 8 |
| C3 | 0.06 | 3 | | | | | | | | | | 25 + 30 | 8 + 8 |
| C4 | 1 | | | | | | | | | | | 25 | 30 |
| C5 | 0.06 | 3 | | | | | | | | | | 40 | 8, 16, 30 |
| C6 | 0.06 | 3 | | | | | | | | | | 50 | 8, 16, 30 |
| C7 | 0.06 | 3 | | | | | | | | | | 70 | 8, 16, 30 |
| C8 | 0.2 | 3 | | | | | | | | | | 50 | 8, 16, 30 |
| C9 | 0.2 | 3 | | | | | | | | | | 70 | 8, 16, 30 |
| C10 | 0.06 | 9 | | | | | | | | | | 50 | 8, 16, 30 |
| C11 | 0.03 | 9 | | | | | | | | | | 70 | 2, 4, 8 |
| C12 | 0.06 | 9 | | | | | | | | | | 70 | 2, 4, 8, 16, 30 |
| T1 | 0.06 | 3 | 5 | | | | | | | | | 30 | 4, 8, 16, 30 |
| T2 | 0.06 | 3 | 5 | | | | | 0.1 | | | | 30 | 4, 8, 16, 30 |
| T3 | 0.06 | 3 | | | 5 | | | | | | | 30 | 4, 8, 16, 30 |
| T4 | 0.06 | 3 | | | 5 | | | 0.1 | | | | 30 | 4, 8, 16, 30 |
| T5 | 0.06 | 3 | | | | 5 | | | | | | 30 | 4, 8, 16, 30 |
| T6 | 0.06 | 3 | | | | 5 | | 0.1 | | | | 30 | 4, 8, 16, 30 |
| T7 | 0.06 | 3 | | | | 5 | | 0.1 | | | | 40 | 8, 16, 30 |
| T8 | 0.06 | 3 | | | | 10 | | 0.1 | | | | 40 | 8, 16, 30 |
| T9 | 0.06 | 3 | | | | | 3 | | | | | 30 | 4, 8, 16, 30 |
| T10 | 0.06 | 3 | | | | | 5 | | | | | 40 | 8, 16, 30 |
| T11 | 0.06 | 3 | | | | | 5 | | | | | 50 | 8, 16, 30 |
| T12 | 0.06 | 3 | | | | | 3 | 0.1 | | | | 30 | 4, 8, 16, 30 |
| T13 | 0.06 | 3 | | | | | 3 | 0.1 | | | | 40 | 8, 16, 30 |
| T14 | 0.06 | 3 | | | | | 5 | 0.1 | | | | 40 | 8, 16, 30 |
| T15 | 0.06 | 3 | | | | | 5 | 0.1 | | | | 50 | 8, 16, 30 |
| T16 | 0.06 | 3 | | | | | 5 | | | 0.2 | | 40 | 8, 16, 30 |
| T17 | 0.06 | 3 | | | | | 5 | 0.1 | | 0.2 | | 40 | 8, 16, 30 |
| T18 | 0.06 | 3 | | | | | 3 | | 1 | | | 40 | 8, 16, 30 |
| T19 | 0.06 | 3 | | 5 | | | | | | | | 30 | 4, 8, 16, 30 |
| T20 | 0.06 | 3 | | 10 | | | | | | | | 40 | 8, 16, 30 |
| T21 | 0.06 | 3 | | 10 | | | | | | | | 50 | 8, 16, 30 |
| T22 | 0.06 | 3 | | 5 | | | | 0.1 | | | | 30 | 4, 8, 16, 30 |
| T23 | 0.06 | 3 | | 5 | | | | 0.1 | | | | 40 | 8, 16, 30 |
| T24 | 0.06 | 3 | | 10 | | | | 0.1 | | | | 40 | 8, 16, 30 |
| T25 | 0.06 | 3 | | 10 | | | | 0.1 | | | | 50 | 8, 16, 30 |
| T26 | 0.06 | 3 | | 10 | | | | | | 0.2 | | 40 | 8, 16, 30 |
| T27 | 0.06 | 3 | | 10 | | | | 0.1 | | 0.2 | | 40 | 8, 16, 30 |
| T28 | 0.06 | 3 | | 10 | | | | 0.1 | | | 5 | 40 | 8, 16, 30 |
| T29 | 0.06 | 3 | | 10 | | | | 0.1 | | | 10 | 40 | 8, 16, 30 |

In Table 1, C1-C12 are controls, IDA is iminodiacetic acid, EDTA is ethylenediaminetetraacetic acid, TEA is triethanolamine. Each numerical value in Table 1 shall be construed as a range of ±10% of the numerical value centered at the numerical value. Each solution in Table 1 consists of water and the ingredients listed.

Except C4, all the other control solutions (C1-C3 and C5-C12) are aqueous solutions of hydrofluoric acid (HF) and sulfuric acid (H₂SO₄) of various concentrations. C4 is an aqueous solution of HF only. C4 causes serious damage to the low-k film at room temperature. C1-C3 and C5-C7 have HF concentration of 0.06% and sulfuric acid concentration of 3%. C1-C3 and C5-C7 are not very effective in removing sidewall polymer at 30° C. even with an extended cleaning time of 30 seconds. At higher temperature, C1-C3 and C5-C7 are only slightly effective but cause serious damage to the low-k film. C8-C9 have higher HF concentration (0.2%) and 3% sulfuric acid and cause serious damage to the low-k film with cleaning times as short as 8 seconds. C10-C12 have higher concentrations of sulfuric acid (9%) and show improved cleaning effectiveness over C1-C9. However, the controls C1-C12 show that higher temperature and/or higher HF concentration tend to cause more damage to the low-k film.

In a series of tests T1-T29, a variety of carboxylic acids, amines and/or ammonium salts (as chelating agent) have been added to a base solution of 0.06% HF and 3% of sulfuric acid, in order to evaluate the cleaning effectiveness and damage to the low-k film.

The effect of acetic acid was evaluated by comparing the solutions in T1 and C1. T1 did not show significant improvement in cleaning effectiveness over C1. The effect of combining acetic acid and ammonium fluoride was evaluated by comparing the solutions in T2 to T1. With cleaning time less than 30 seconds, T2 did not show significant improvement in cleaning effectiveness over T1. With cleaning time of 30 seconds, however, T2 exhibited improvement in cleaning effectiveness over T1.

The effect of citric acid was evaluated by comparing T3 and C1. T3 did not show significant improvement in cleaning effectiveness over C1. The effect of combining citric acid and ammonium fluoride was evaluated by comparing T4 to T3. T4 did not show improvement in cleaning effectiveness over T3 with cleaning times from 4 to 30 seconds.

The effect of malic acid was evaluated by comparing T5 and C1. With cleaning time of 4 seconds, T5 did not show significant improvement in cleaning effectiveness over C1. With longer cleaning times (8, 16 and 30 seconds), T5 exhibited significant improvement in cleaning effectiveness over C1. The effect of combining malic acid and ammonium fluoride was evaluated by comparing T6 to T5. T6 did not show improvement in cleaning effectiveness over T5 with cleaning times from 4 to 16 seconds and exhibited some improvement in cleaning effectiveness over T5 with cleaning time of 30 seconds.

T7 was conducted at higher temperature than T6. T7 did not show significant improvement in cleaning effectiveness over T6 but caused more damage to the low-k film. T8 has a higher concentration of malic acid than T7. T8 exhibited slight improvement in cleaning effectiveness over T7 with cleaning times from 4 to 30 seconds.

The effect of IDA was evaluated by comparing T9 to C1, T10 to C5, and T11 to C6. T9 exhibited significant improvement in cleaning effectiveness over C1. T10 did not show significant improvement in cleaning effectiveness over C5. T11 did not show significant improvement in cleaning effectiveness over C6. The effect of combining IDA and ammonium fluoride was evaluated by comparing T12 to T9, T14 to T10 and T15 to T11. T12, T14 and T15 exhibited some improvement in cleaning effectiveness over T9, T10 and T11 respectively, with increased cleaning times from 4 to 30 seconds.

T11 was conducted at higher temperature than T10. T11 exhibited slight improvement in cleaning effectiveness over T10 without causing more damage to the low-k film.

The effect of combining ammonium hydrogen fluoride (NH₄HF₂) and IDA was evaluated by comparing T18 to T9. T18 exhibited significant damage to the low-k film. Comparing cleaning effectiveness of T17 and T14 and comparing cleaning effectiveness of T16 and T10 demonstrated that adding EDTA to T14 and T10 significantly improves their cleaning effectiveness.

Comparing cleaning effectiveness of T14 and T13 shows that increasing the concentration of IDA in T13 improves its cleaning effectiveness significantly.

The effect of oxalic acid was evaluated by comparing T19 to C1, T20 to C5 and T21 to C6. T19 does not show significant improvement in cleaning effectiveness over C1 with cleaning times of 4, 8 and 16 seconds. T19 shows significant improvement in cleaning effectiveness over C1 with cleaning time of 30 seconds. T20 exhibited slight improvement in cleaning effectiveness over C5 with cleaning times of 8, 16 and 30 seconds. T21 did not show significant improvement in cleaning effectiveness over C6 with cleaning time of 8 seconds. T21 exhibited significant improvement in cleaning effectiveness over C6 with cleaning times of 16 and 30 seconds. The effect of combining oxalic acid and ammonium fluoride was evaluated by comparing T25 to T21, T23 to T20 and T22 to T19. T25 exhibited significant improvement in cleaning effectiveness over T21 with cleaning time of 8 seconds. Above 8 seconds, T25 exhibited significant damage to the low-k film. T23 did not show significant improvement in cleaning effectiveness over T20. T22 did not show significant improvement in cleaning effectiveness over T19 with cleaning time of 8 seconds. T22 shows significant improvement in cleaning effectiveness over T19 with cleaning times of 16 and 30 seconds.

Comparing cleaning effectiveness of T28, T29 and T24 shows that adding 5-10% of TEA to the T24 composition does not significantly improve the cleaning effectiveness of T24.

Comparing cleaning effectiveness of T27 to T24 and T26 to T20 shows that adding 0.2% EDTA to the T24 composition and to the T20 composition significantly improves their cleaning effectiveness. T23 and T24 did not show much difference between their cleaning effectiveness despite their difference in oxalic acid concentration. T21, T23 and T25 were conducted at higher temperatures than, and showed significant improvement of cleaning effectiveness over T20, T22 and T24, respectively.

Table 2 summarizes cleaning effectiveness and damage to the low-k film of T1-T29.

TABLE 2

| | Sidewall Polymer | | | | | | | |
|---|---|---|---|---|---|---|---|---|
| | Cleaning Effectiveness | | | | Damage to the Low-k Film | | | |
| Test | 4 sec | 8 sec | 16 sec | 30 sec | 4 sec | 8 sec | 16 sec | 30 sec |
| T1 | − | − | − | − | + | + | + | + |
| T2 | − | − | − | − | + | + | + | + |
| T3 | − | − | − | − | + | + | + | + |
| T4 | − | − | − | − | + | + | + | + |
| T5 | − | O | O | O | + | + | + | + |
| T6 | − | O | O | + | + | + | + | + |
| T7 | n/a | − | O | O | n/a | + | + | + |
| T8 | n/a | − | O | O | n/a | + | + | + |
| T9 | − | − | O | O | + | + | + | + |
| T10 | n/a | − | O | O | n/a | + | + | + |
| T11 | n/a | − | O | O | n/a | + | + | + |
| T12 | − | − | O | O | + | + | + | + |
| T13 | n/a | O | O | O | n/a | + | + | + |
| T14 | n/a | O | O | + | n/a | + | + | + |
| T15 | n/a | O | O | + | n/a | + | + | + |
| T16 | n/a | O | O | + | n/a | + | + | + |
| T17 | n/a | O | + | + | n/a | + | + | + |
| T18 | n/a | O | O | + | n/a | − | − | − |
| T19 | − | O | O | + | + | + | + | + |
| T20 | n/a | O | O | + | n/a | + | + | + |
| T21 | n/a | O | + | + | n/a | + | + | + |
| T22 | − | O | O | O | + | + | + | + |
| T23 | n/a | O | + | + | n/a | + | + | + |
| T24 | n/a | O | + | + | n/a | + | + | + |
| T25 | n/a | + | + | + | n/a | + | − | − |
| T26 | n/a | O | + | + | n/a | + | + | + |
| T27 | n/a | O | + | + | n/a | + | + | + |
| T28 | n/a | O | O | + | n/a | + | + | + |
| T29 | n/a | + | + | + | n/a | + | + | + |

In the “Sidewall Polymer Cleaning Effectiveness” columns, “+”, “O”, “−”, mean very effective, somewhat effective and slightly effective, respectively. In the “Damage to the Low-k Film” columns, “+”, “−”, mean no visible damage, serious damage, respectively.

The cleaning solution is preferably free of alcohols, peroxides (e.g. hydrogen peroxide) and esters. The cleaning solution is a water based (aqueous) solution of 0.01 to 0.1% of HF, 1 to 5% of sulfuric acid, 1 to 15% of a carboxylic acid, up to 2% of one or more species of chelating agent, up to 15% of one or more species of amine and preferably with 75% or more of water. The cleaning solution can also be free of ammonium hydroxide, chelating agent, amine, nitric acid and/or surfactant. The carboxylic acid can be acetic acid (preferably 1 to 10%, more preferably 4 to 6%), oxalic acid (preferably 1 to 15%, more preferably 4 to 11%), citric acid (preferably 1 to 10%, more preferably 4 to 6%), malic acid (preferably 1 to 15%, more preferably 4 to 11%), or iminodiacetic acid (preferably 1 to 10%, more preferably 2 to 6%). The chelating agent can be ammonium fluoride (preferably 0.01 to 0.2%), ammonium hydrogen fluoride (preferably 0.9 to 1.1%) and/or ethylenediaminetetraacetic acid (preferably 0.1 to 0.3%). The amine is preferably triethanolamine (preferably 4 to 11%). The cleaning solution preferably has equal or higher concentration of carboxylic acid than sulfuric acid. A concentration ratio of the carboxylic acid to the chelating agent in the cleaning solution is preferably at least 10:1. A concentration ratio of sulfuric acid to the chelating agent in the cleaning solution is preferably at least 10:1.

A method of using the cleaning solution for removing sidewall polymer of a damascene process on a wafer containing one or more metallic interconnect materials such as Al or Cu and a low-k interlayer dielectric material can comprise immersing the wafer in the cleaning solution maintained at a temperature from 30 to 70° C. for up to 40 seconds, more preferably 8 to 30 seconds.

While the cleaning solution and the method of using the cleaning solution have been described in detail with reference to specific embodiments thereof, it will be apparent to those skilled in the art that various changes and modifications can be made, and equivalents employed, without departing from the scope of the appended claims.

We claim:

1. An aqueous cleaning solution effective for removing sidewall polymer produced during a damascene process on a wafer containing one or more metallic interconnect materials and one or more low-k interlayer dielectric material films, the cleaning solution comprising:
0.01 to 0.1 w/w % of hydrofluoric acid,
1 to 5 w/w % of sulfuric acid,
1 to 15 w/w % of a carboxylic acid,
up to 2 w/w % of one or more species of chelating agent,
up to 15 w/w % of one or more species of amine, and
75 w/w % or more of water;
wherein the cleaning solution does not damage the one or more low-k interlayer dielectric material films.

2. The cleaning solution of claim 1, wherein the carboxylic acid is oxalic acid, malic acid, or iminodiacetic acid.

3. The cleaning solution of claim 1, wherein the carboxylic acid is 1 to 15% oxalic acid, 1 to 15% malic acid, or 1 to 10% iminodiacetic acid.

4. The cleaning solution of claim 1, wherein the carboxylic acid is 4 to 11% oxalic acid, 4 to 11% malic acid, or 2 to 6% iminodiacetic acid.

5. The cleaning solution of claim 1, wherein the chelating agent is ammonium fluoride, ammonium hydrogen fluoride, and/or ethylenediaminetetraacetic acid.

6. The cleaning solution of claim 1, comprising an effective amount of the chelating agent, wherein the chelating agent is 0.01 to 0.2% ammonium fluoride, 0.9 to 1.1% ammonium hydrogen fluoride, and/or 0.1 to 0.3% ethylenediaminetetraacetic acid.

7. The cleaning solution of claim 1, wherein the amine is 4 to 11% triethanolamine.

8. The cleaning solution of claim 1, wherein a concentration of the carboxylic acid is equal to or higher than a concentration of sulfuric acid.

9. The cleaning solution of claim 1, wherein a concentration ratio of the carboxylic acid to the chelating agent is at least 10:1.

10. The cleaning solution of claim 1, wherein a concentration ratio of the sulfuric acid to the chelating agent is at least 10:1.

11. The cleaning solution of claim 1, wherein the cleaning solution is free of alcohols, peroxides and esters.

12. The cleaning solution of claim 1, wherein the cleaning solution is free of hydrogen peroxide.

13. The cleaning solution of claim 1, wherein the cleaning solution is free of ammonia.

14. The cleaning solution of claim 1, wherein the cleaning solution is free of ammonium hydroxide.

15. The cleaning solution of claim 1, wherein the cleaning solution is free of the one or more species of chelating agent.

16. The cleaning solution of claim 1, wherein the cleaning solution is free of the one or more species of amine.

17. The cleaning solution of claim 1, wherein the cleaning solution is free of nitric acid.

18. The cleaning solution of claim 1, wherein the cleaning solution is free of the one or more species of surfactant.

19. A method of using the cleaning solution of claim 1 for removing sidewall polymer on plasma etched features produced during a damascene process on a wafer containing one or more metallic interconnect materials and one or more low-k interlayer dielectric material films, the method comprising immersing the wafer in the cleaning solution maintained at a temperature from 30 to 70° C. for up to 40 seconds, the cleaning solution effectively removing the sidewall polymer with minimal damage to the metallic interconnect materials and the one or more low-k interlayer dielectric material films.

20. The method of claim 19, wherein the wafer is immersed in the cleaning solution for 8 to 30 seconds.
